(19) United States
(12) Patent Application Publication
(10) Pub. No.: US 2024/0362549 A1
(43) Pub. Date: Oct. 31, 2024

(54) METHODS AND INTERNET OF THING SYSTEMS FOR SUPERVISING ENTERPRISE INFORMATION BASED ON SMART GAS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Lei ZHANG, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 18/766,565

(22) Filed: Jul. 8, 2024

(30) Foreign Application Priority Data
Jun. 17, 2024 (CN) 202410772847.5

(51) Int. Cl. G06Q 10/0631; G16Y 10/35; G16Y 40/10; G16Y 40/35; G16Y 40/50

(52) U.S. Cl. CPC G06Q 10/0631; G16Y 10/35; G16Y 40/10; G16Y 40/35; G16Y 40/50

(57) ABSTRACT

Disclosed is a method for supervising enterprise information based on smart gas, implemented by a smart gas government safety supervision management platform of an IoT system for supervising enterprise information based on smart gas. The method includes: determining a gas data list; determining a correlation between gas terminal enterprises; determining one or more gas terminal enterprise groups; determining, for each group of the one or more gas terminal enterprise groups, a first upload characteristic of gas terminal enterprises in the group; determining a data upload instruction and sending the data upload instruction to a corresponding gas terminal enterprise; obtaining sampling data uploaded by the gas terminal enterprises; determining a second upload characteristic of the gas terminal enterprises in each group of the one or more gas terminal enterprise groups; and generating an upload parameter instruction, which instructs the gas sensing devices to collect and upload auxiliary data.

### CROSS-REFERENCE TO RELATED APPLICATIONS

This application claims priority to Chinese Patent Application No. 202410772847.5, filed on Jun. 17, 2024, the entire content of which is incorporated herein by reference.

### TECHNICAL FIELD

The present disclosure relates to the field of gas information processing and Internet of Things (IoT), and in particular relates to methods and Internet of Things systems for supervising enterprise information based on smart gas.

### BACKGROUND

With an increasingly wide range of gas usage and an increasing count of gas terminal enterprises, it is increasingly important to collect, integrate, and analyze gas usage information of different gas terminal enterprises. CN 111062575 B provides an Internet of Things (IoT)-based operation platform and method for gas industry, and an operation method of the same, which includes an intelligent gas device for forming a communication link with the IoT, an IoT transmission subsystem for providing a connection channel, a security authentication subsystem for device authentication, and a gas business planning subsystem for forming a control strategy. However, CN 111062575 B does not take into account a correlation between enterprises and does not provide a personalized data collection manner.

Therefore, methods and Internet of Things systems for supervising enterprise information based on smart gas are provided, which help to summarize different gas terminal enterprises so as to provide efficient and convenient data feedback based on the correlation between enterprises, thereby improving efficiency of gas data interaction across enterprises and departments, and ensuring safety of gas usage.

### SUMMARY

One or more embodiments of the present disclosure provide method for supervising enterprise information based on smart gas, implemented by a smart gas government safety supervision management platform of an Internet of Things (IoT) system for supervising enterprise information based on smart gas. The method may include: determining a gas data list, wherein the gas data list includes at least one of a periodic check list or a statistical list; determining a correlation between gas terminal enterprises based on the gas data list and types of the gas terminal enterprises; determining one or more gas terminal enterprise groups by performing a labeling process on the gas terminal enterprises based on the correlation; determining, for each group of the one or more gas terminal enterprise groups, a first upload characteristic of gas terminal enterprises in the group based on grouping of the one or more gas terminal enterprise groups, the first upload characteristic including at least one of a first upload time period or a first upload frequency; determining a data upload instruction based on the first upload characteristic and the gas data list, and sending the data upload instruction to a corresponding gas terminal enterprise among the gas terminal enterprises; obtaining sampling data uploaded by the gas terminal enterprises, the sampling data being collected by one or more groups of gas sensing devices controlled by the gas terminal enterprises based on the data upload instruction; determining a second upload characteristic of the gas terminal enterprises in each group of the one or more gas terminal enterprise groups based on a first priority of each group of the one or more gas terminal enterprise groups and a second priority of each of the gas terminal enterprises in the group, the second upload characteristic including a second upload frequency; and generating an upload parameter instruction based on the second upload characteristic and sending the upload parameter instruction to the one or more groups of gas sensing devices of the gas terminal enterprises for storage, the upload parameter instruction instructing the one or more groups of gas sensing devices to collect and upload auxiliary data.

One or more embodiments of the present disclosure provide an Internet of Things (IoT) system for supervising enterprise information based on smart gas. The system may include a public user platform, a smart gas government safety supervision service platform, a smart gas government safety supervision management platform, a smart gas government safety supervision sensor network platform, a gas user platform, a gas user service platform, a smart gas government safety supervision object platform, a smart gas company sensor network platform, a gas user object platform, and a smart gas device object platform. The smart gas government safety supervision management platform may be configured to: determine a gas data list, wherein the gas data list includes at least one of a periodic check list or a statistical list, and the gas data list is uploaded to the smart gas government safety supervision sensor network platform through the smart gas government safety supervision management platform; determine, based on the smart gas government safety supervision object platform, a correlation between gas terminal enterprises based on the gas data list and types of the gas terminal enterprises; determine, based on the smart gas government safety supervision object platform, one or more gas terminal enterprise groups by performing a labeling process on the gas terminal enterprises based on the correlation; determine, for each group of the one or more gas terminal enterprise groups, a first upload characteristic of gas terminal enterprises in the group based on grouping of the one or more gas terminal enterprise groups, the first upload characteristic including at least one of a first upload time period or a first upload frequency; determine a data upload instruction based on the first upload characteristic and the gas data list, and send the data upload instruction to a corresponding gas terminal enterprise among the gas terminal enterprises; obtain sampling data uploaded by the gas terminal enterprises, the sampling data being collected by one or more groups of gas sensing devices controlled by the gas terminal enterprises based on the data upload instruction; determine a second upload characteristic of the gas terminal enterprises in each group of the one or more gas terminal enterprise groups based on a first priority of each group of the one or more gas terminal enterprise groups and a second priority of each of the gas terminal enterprises in the group, the second upload characteristic including a second upload frequency; and generate an upload parameter instruction based on the second upload characteristic and send the upload parameter instruction to the one or more groups of gas sensing devices of the gas terminal enterprises for storage, the upload parameter instruction instructing the one or more groups of gas sensing devices to collect and upload auxiliary data.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a system schematic diagram illustrating an IoT system for supervising enterprise information based on smart gas according to some embodiments of the present disclosure;

FIG. 2 is a flowchart illustrating an exemplary process of a method for supervising enterprise information based on smart gas according to some embodiments of the present disclosure;

FIG. 3 is a schematic diagram illustrating a correlation model of an IoT system according to some embodiments of the present disclosure;

FIG. 4 is a flowchart illustrating an exemplary process for determining a correlation according to some embodiments of the present disclosure;

FIG. 5 is a flowchart illustrating an exemplary process for obtaining sampling data according to some embodiments of the present disclosure; and

FIG. 6 is a flowchart illustrating an exemplary process for obtaining sampling data according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, the operations may be executed in reverse order or simultaneously. Additionally, one or more other operations may be added to these processes, or one or more operations may be removed from these processes.

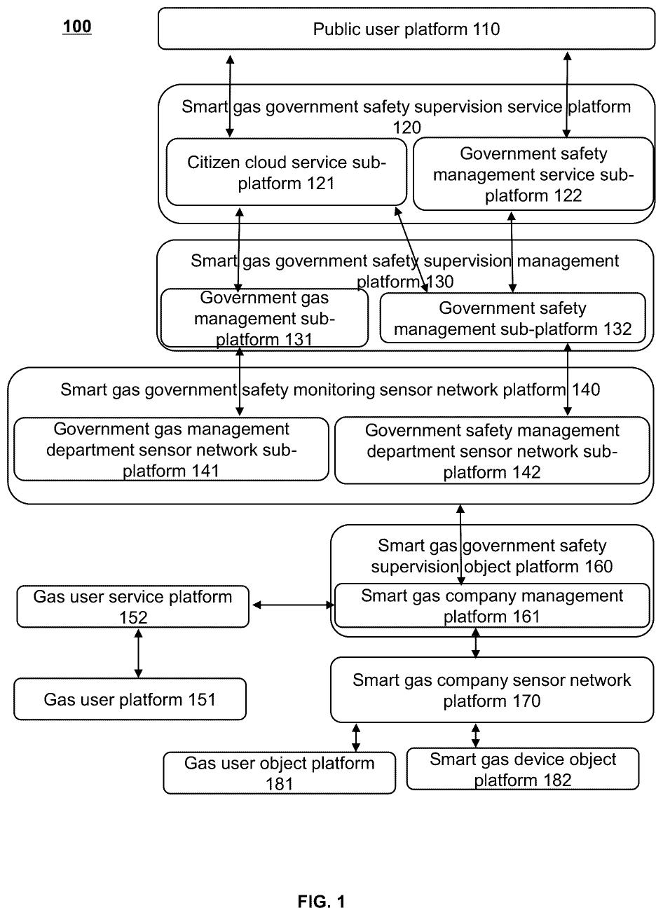

FIG. 1 is a system schematic diagram illustrating an IoT system for supervising enterprise information based on smart gas according to some embodiments of the present disclosure. The IoT system for supervising enterprise information based on smart gas includes a public user platform 110, a smart gas government safety supervision service platform 120, a smart gas government safety supervision management platform 130, a smart gas government safety supervision sensor network platform 140, a gas user platform 151, a gas user service platform 152, a smart gas government safety supervision object platform 160, a smart gas company sensor network platform 170, a gas user object platform 181, and a smart gas device object platform 182.

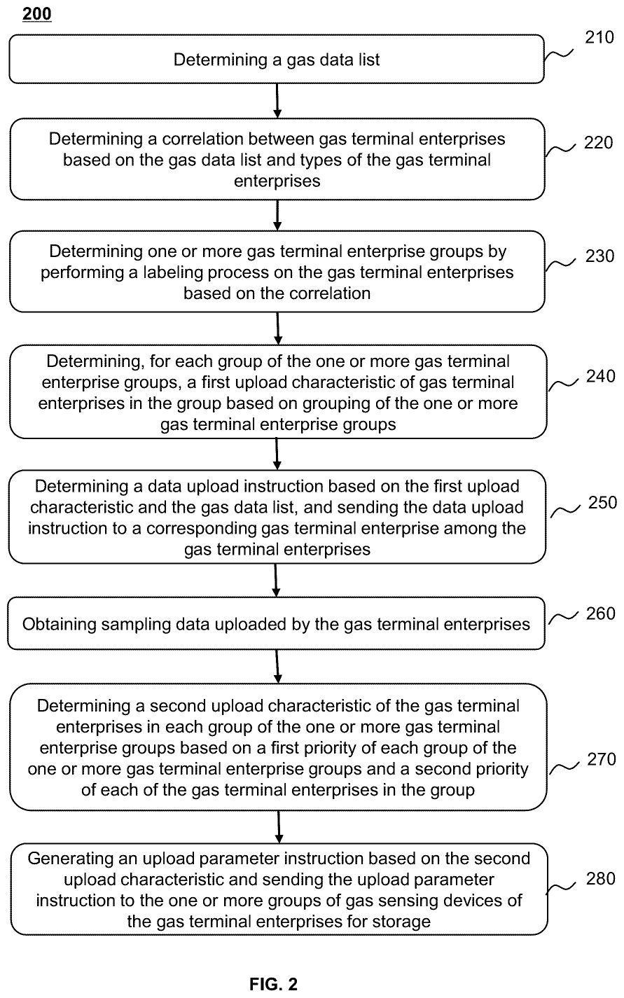

The public user platform 110 is a platform configured to announce gas announcement information. More descriptions of the gas announcement information may be found in the related descriptions of FIG. 2.

The smart gas government safety supervision service platform 120 is a platform for the government to provide smart gas safety supervision services. In some embodiments, the smart gas government safety supervision service platform 120 includes a citizen cloud service sub-platform 121 and a government safety management service sub-platform 122.

The smart gas government safety supervision management platform 130 is a platform for the government to provide smart gas safety supervision and management. In some embodiments, the smart gas government safety supervision management platform 130 includes a government gas management sub-platform 131 and a government safety management sub-platform 132. The smart gas government safety supervision management platform 130 may be configured to implement a method for supervising enterprise information based on smart gas. More descriptions of the method for supervising enterprise information based on smart gas may be found in the related descriptions of FIG. 2.

The smart gas government safety monitoring sensor network platform 140 is a platform for the government to provide a smart gas safety monitoring sensor network. In some embodiments, the smart gas government safety supervision sensor network platform 140 includes a government gas management department sensor network sub-platform 141 and a government safety management department sensor network sub-platform 142.

The gas user platform 151 is a platform directly interfaces with gas users and acts as a platform for retrieving sampling data. More descriptions of the sampling data may be found in the related descriptions of FIG. 2.

The gas user service platform 152 is a platform that obtains the sampling data from one or more gas user platforms 151. In some embodiments, the gas user service platform 152 may interact with the one or more gas user platforms 151 for data exchange. For example, the gas user service platform 152 may receive the sampling data from the one or more gas user platform 151.

The smart gas government safety supervision object platform 160 is a platform for determining a correlation between different gas terminal enterprises and labelling the gas terminal enterprises. More descriptions of determining the correlation and labeling may be found in the related descriptions of FIG. 2. In some embodiments, the smart gas government safety supervision object platform 160 includes a smart gas company management platform 161, the smart gas company management platform being configured to be in data communication with one or more gas terminal enterprises for data communication.

The smart gas company sensor network platform 170 is a platform for obtaining the sampling data from one or more gas user object platforms 181 and one or more smart gas device object platforms 182. In some embodiments, the smart gas company sensor network platform 170 may interact with one or more the gas user object platforms 181 and the one or more smart gas device object platforms 182 for data exchange. For example, the smart gas company sensor network platform 170 may receive the sampling data from the one or more gas user object platform 181 and the one or more smart gas device object platform 182.

The gas user object platform 181 and the smart gas device object platform 182 are platforms through which the sampling data may be retrieved.

In some embodiments, the public user platform 110 may interact with the citizen cloud service sub-platform 121 and the government safety management service sub-platform 122; the government gas management sub-platform 131 may interact with the citizen cloud service sub-platform 121 and the government gas management department sensor network sub-platform 141. The government safety management sub-platform 132 may interact with the citizen cloud service sub-platform 121, the government safety management service sub-platform 122, and the government safety management department sensor network sub-platform 142. The smart gas company management platform 161 may interact with the smart gas government safety supervision sensor network platform 140, the gas user service platform 152, and the smart gas company sensor network platform 170. The gas user service platform 152 may interact with the gas user platform 151, such as receiving the sampling data from the gas user platform 151. The smart gas company sensor network platform 170 may interact with the gas user object platform 181 and the smart gas device object platform 182, such as receiving the sampling data from the gas user object platform 181 and the smart gas device object platform 182.

FIG. 2 is a flowchart illustrating an exemplary process of a method for supervising enterprise information based on smart gas according to some embodiments of the present disclosure. As shown in FIG. 2, a process 200 includes the following operations. In some embodiments, the process 200 may be performed by a smart gas government safety supervision management platform of an IoT system for supervising enterprise information based on smart gas.

In 210, determining a gas data list.

The gas data list refers to a statistical list of a plurality of gas data demands for the smart gas government safety supervision management platform. In some embodiments, gas data lists corresponding to different time periods are different, and gas terminal enterprises corresponding to different gas data lists are different. The different types of gas data lists may cater to demands for different types of gas data. For example, a type of gas data list may include statistics on a demand for gas data representing gas production of enterprises. As another example, a type of gas data list may include statistics on a demand for gas data indicating an effectiveness of safety prevention work.

The types of the gas data list include at least one of a periodic check list or a statistical list.

The periodic check list refers to a list of various types of gas data that the smart gas government safety supervision management platform needs to obtain at a preset time point. In some embodiments, the smart gas government safety supervision management platform may generate the periodic inspection list based on an inspection requirement for the gas data.

The statistics list refers to a list of various types of gas data that the smart gas government safety supervision management platform needs to obtain after a preset time period. In some embodiments, the smart gas government safety supervision object platform sends the statistical list to the smart gas government safety supervision management platform through the smart gas company sensor network platform.

In 220, determining a correlation between gas terminal enterprises based on the gas data list and types of the gas terminal enterprises.

A gas terminal enterprise is a gas-related business. The types of the gas terminal enterprises may reflect types of enterprises that use gas for different production, processing, and manufacturing activities. For example, the types of the gas terminal enterprises may include gas heating enterprises, gas power generation enterprises, gas metallurgy enterprises, or the like.

The correlation between gas terminal enterprises refers to a degree of association between different the gas terminal enterprises. The correlation may indicate a difference in the types of gas terminal enterprises between different gas terminal enterprises and a difference in the corresponding gas data lists. If the correlation between the gas terminal enterprises is higher, the difference in the types of the gas terminal enterprises is smaller, and the difference in the gas data lists corresponding to the gas terminal enterprises is smaller. For example, if gas terminal enterprise A and gas terminal enterprise B correspond to a same gas data list, the correlation between gas terminal enterprise A and gas terminal enterprise B is higher.

In some embodiments, the correlation may dynamically change based on a change in the types of the gas terminal enterprises or a change in the gas data list presented by the smart gas government safety supervision management platform.

In some embodiments, the smart gas government safety supervision management platform may determine the correlation by determining a vector distance. The smart gas government safety supervision management platform may construct feature vectors based on current gas terminal enterprises, with each feature vector including elements such as the type of a current gas terminal enterprise and the gas data list corresponding to the current gas terminal enterprise.

The smart gas government safety supervision management platform may determine the vector distance between the feature vectors and determine, by querying a first preset table, the correlation between the gas terminal enterprises corresponding to the feature vectors. The first preset table includes a correspondence between the vector distance between the feature vectors and the correlation. For example, the larger the vector distance is, the smaller the correlation is. The first preset table may be determined based on prior experience or historical data.

In some embodiments, the smart gas government safety supervision management platform may establish a correlation map based on the gas data list and the types of the gas terminal enterprise, and predict the correlation between the gas terminal enterprises at a future time point based on the correlation map.

The correlation map is a representation of the correlation between the gas terminal enterprises.

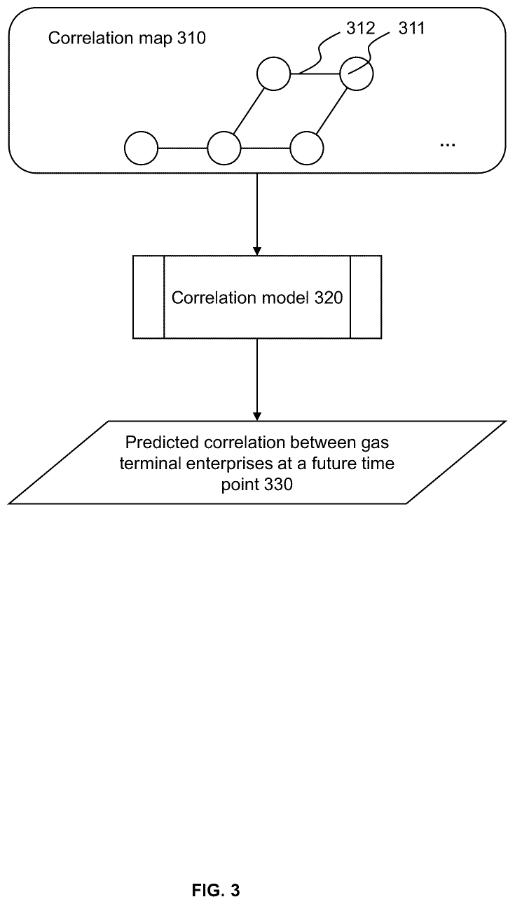

The correlation map may include a plurality of nodes and a plurality of edges. More descriptions of the nodes and edges of the correlation map may be found in the corresponding descriptions of FIG. 3.

In some embodiments, the types of the gas terminal enterprise include information of types of correlation enterprises and information of types of gas usage, wherein the types of correlation enterprises may include a first correlation enterprise and a second correlation enterprise. The first correlation enterprise refers to a gas terminal enterprise that has a greater relevance to gas, and the second correlation enterprise refers to a gas terminal enterprise that has a lower relevance to gas. The types of gas usage may include the aforementioned gas heating enterprises, gas power generation enterprises, gas metallurgy enterprises, or the like.

In some embodiments, the types of the gas terminal enterprises may be determined based on an amount of gas consumption of the gas terminal enterprises over a preset historical time period and a purpose of gas consumption. The relevance of a gas terminal enterprises is positively correlated with the amount of gas consumption of the gas terminal enterprise during the preset historical time period.

The smart gas government safety supervision management platform may determine the relevance of the gas terminal enterprises in a variety of ways, thereby determining the types of the gas terminal enterprises. For example, the smart gas government safety supervision management platform may determine the types of the gas terminal enterprises using Equation (1):

$$μ = {Σ}_{i = 1}^{n} {C}_{i} \times {e}^{- {t}_{i}} \qquad ( 1 )$$

Wherein u denotes the relevance of a gas terminal enterprise, n denotes a count of preset historical time periods, and Cᵢ denotes the amount of gas consumption of the gas terminal enterprise in the preset historical time period tᵢ. The preset historical time period may be an interval between a median of time periods corresponding to the gas consumption and a current time.

In some embodiments, the smart gas government safety supervision management platform may determine a gas terminal enterprise that satisfies a preset relevance condition as the first correlation enterprise, and a gas terminal enterprise that does not satisfy the preset relevance condition as the second correlation enterprise. The preset relevance condition is a criterion for determining the relevance of a gas terminal enterprise. For example, the preset relevance condition may be that the relevance of a gas terminal enterprise is greater than a preset relevance threshold.

In some embodiments, the smart gas government safety supervision management platform may predict the correlation between the gas terminal enterprises by querying a second preset table based on the nodes and edges in the correlation map. The second preset table includes a correspondence between node attributes of nodes and edge attributes of edges in the correlation mapping and the correlation between the gas terminal enterprises corresponding to the nodes and edges. The second preset table may be determined based on prior experience or historical data.

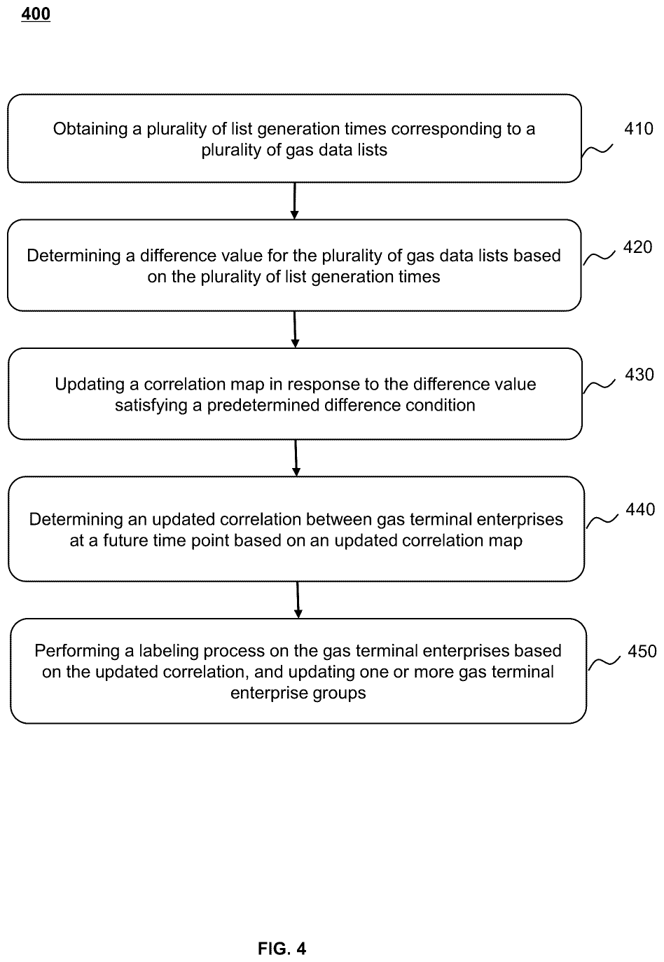

In some embodiments, the smart gas government safety supervision management platform may process the correlation map based on a correlation model, predict and updating the correlation of different edges. More descriptions of the correlation model and updating the correlation may be found in FIG. 3 and FIG. 4 and the related descriptions thereof.

In some embodiments of the present disclosure, by determine the correlation between gas terminal enterprises by means of the correlation map, the correlation between the gas terminal enterprises can be presented more intuitively, thereby facilitating further analysis of enterprise information.

In 230, determining one or more gas terminal enterprise groups by performing a labeling process on the gas terminal enterprises based on the correlation.

A gas terminal enterprise group is a group of gas terminal enterprises. In some embodiments, the smart gas government safety supervision object platform may, based on the correlation, divide values of the correlation into at least one value range, and perform the labeling process on gas terminal enterprises whose values of correlation is with a same value range, thereby determining the one or more gas terminal enterprise groups. The smart gas government safety supervision object platform may divide the at least one value range of the correlation based on a manually preset range. For example, the smart gas government safety supervision object platform may divide the values of the correlation into three value ranges: correlation with values less than 10, correlation with values ranging from 10 to 20, and correlation with values greater than 20.

In 240, determining, for each group of the one or more gas terminal enterprise groups, a first upload characteristic of gas terminal enterprises in the group based on grouping of the one or more gas terminal enterprise groups.

The first upload characteristic refers to a first upload feature when uploading data in bulk. In some embodiments, the first upload characteristic may include at least one of a first upload time period or a first upload frequency.

The first upload time period is a time period for centralized uploading of large volumes of gas data. For example, gas terminal enterprise group A may centralize the uploading of data in a time period from 9:00 to 11:00 a.m., and gas terminal enterprise group B may centralize the uploading of data in a time period from 11:00 a.m. to 12:00 p.m.

The first upload frequency is the count of times gas data is uploaded within a unit of time.

In some embodiments, the smart gas government safety supervision object platform may determine the first upload characteristic based on the correlation between gas terminal enterprises, gas data lists, and gas terminal enterprise groups that need to upload data by querying a third preset table. The third preset table includes a correspondence between the first upload characteristic and the gas data lists, the gas terminal enterprise groups that need to upload the data, and the correlation corresponding to the gas terminal enterprise groups.

The third preset table may be determined based on prior experience or historical data. For example, the greater the correlation between gas terminal enterprises corresponding to a gas data list is, the earlier the first upload period is for uploading gas data, and the higher the first upload frequency is. The gas terminal enterprises corresponding to the gas data list are enterprises that need to obtain the corresponding data in the gas data list.

In 250, determining a data upload instruction based on the first upload characteristic and the gas data list, and sending the data upload instruction to a corresponding gas terminal enterprise among the gas terminal enterprises.

The data upload instruction may control the gas terminal enterprise to upload gas data. The data upload instruction may include information such as the gas terminal enterprise that upload gas data, the first upload characteristic, or the like. In some embodiments, the smart gas government safety supervision object platform may send the data upload instruction to the gas terminal enterprises sequentially through the smart gas government safety supervision sensor network platform, the smart gas government safety supervision object platform, and the smart gas company sensor network platform.

In 260, obtaining sampling data uploaded by the gas terminal enterprises.

The sampling data is collected by one or more groups of gas sensing devices controlled by the gas terminal enterprises based on the data upload instruction.

The sampling data refers to supervision data related to gas. In some embodiments, the gas terminal enterprises may control one or more groups of gas sensing devices to collect sampling data and upload the sampling data through a gas communication device. After receiving the sampling data uploaded by the gas terminal enterprises through the smart gas company sensor network platform, the smart gas government safety supervision object platform uploads the data to the smart gas government safety supervision management platform via the smart gas government safety supervision sensor network platform.

A gas sensing device refers to a sensor related to gas. A gas communication device is a device that may be used for transmission of gas-related data.

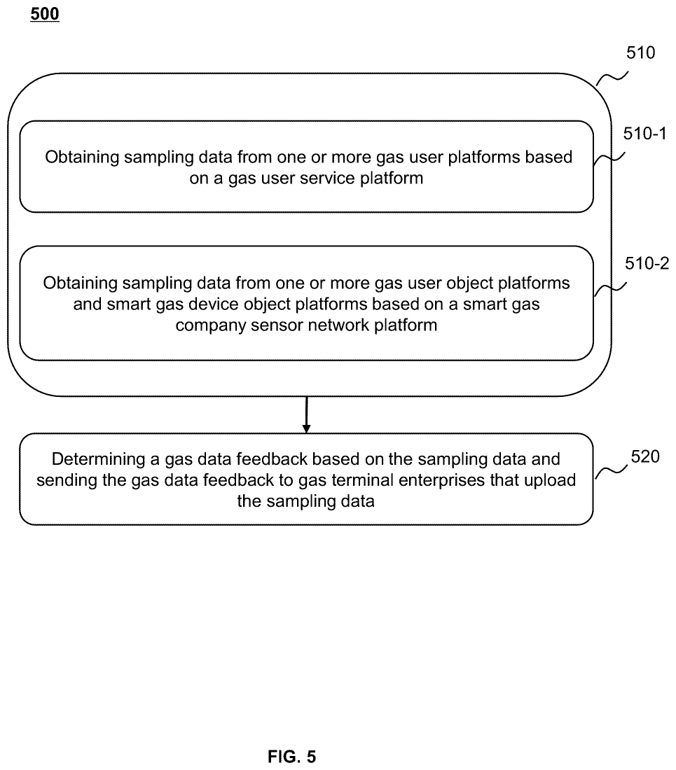

More descriptions of obtaining the sampling data may be found in FIG. 5 and the related descriptions.

In 270, determining a second upload characteristic of the gas terminal enterprises in each group of the one or more gas terminal enterprise groups based on a first priority of each group of the one or more gas terminal enterprise groups and a second priority of each of the gas terminal enterprises in the group.

The first priority is a parameter that reflects priority levels of different gas terminal enterprise groups. The higher the first priority is, the higher the priority of the corresponding gas terminal enterprise group for data upload.

In some embodiments, the smart gas government safety supervision management platform may determine the first priority based on the count of members and primary categories of different gas terminal enterprise groups by querying a fourth preset table. The primary categories of gas terminal enterprise groups may include heating, power generation, metallurgy, or the like, and may be determined based on the main types of gas terminal enterprises within the groups. The fourth preset table includes a correspondence between the count of members and primary categories of different gas terminal enterprise groups and the corresponding first priority. The fourth preset table may be determined based on prior experience or historical data. For example, the count of members of the gas terminal enterprise groups may be positively correlated with the first priority.

The second priority is a parameter that reflects priority levels of different gas terminal enterprises within a same gas terminal enterprise group. The higher the second priority, the higher the priority level of the corresponding gas terminal enterprise for data upload.

In some embodiments, the smart gas government safety supervision management platform may determine the second priority based on the types of the gas terminal enterprises and a time of the gas data list.

The smart gas government safety supervision management platform may determine a type coefficient based on the types of the gas terminal enterprises. The type coefficient is a coefficient that indicates the types of different gas terminal enterprises. For example, the smart gas government safety supervision management platform may set the type coefficient corresponding to the first correlation enterprise to 0.8, and the type coefficient of the second correlation enterprise to 0.3. The type coefficient may be preset manually.

The smart gas government safety supervision management platform may determine a time coefficient based on the time of the gas data list. The time of the gas data list refers to a receipt time or a confirmation of time gas data lists for different gas terminal enterprises within a same gas terminal enterprise group.

The smart gas government safety supervision management platform may sort gas terminal enterprises according to the time of the gas data list. For example, the smart gas government safety supervision management platform may sort the gas data list based on the confirmation time, from early to late, with earlier confirmed gas terminal enterprises being ranked higher, and determine the time coefficient based on the sorting order. For example, if a plurality of gas terminal enterprises are sorted, the time coefficient for a first-ranked gas terminal enterprise is n, the time coefficient for a second-ranked gas terminal enterprise is n−1, and the time coefficient for an nth-ranked gas terminal enterprise is 1.

In some embodiments, the type coefficient and the time coefficient are both positively correlated with the second priority. The smart gas government safety supervision management platform may determine the second priority in a variety of ways, for example, by multiplying the time coefficient and the type coefficient corresponding to the gas terminal enterprise to obtain a second priority score. The second priority may be determined by sorting second priority scores in descending order.

The second upload characteristic is a characteristic of sporadically data uploads. The second upload characteristic may include a second upload frequency and a second upload time period. The second upload time period is the time period during which gas data is sporadically uploaded. The second upload frequency is the count of times a small portion of gas data is uploaded sporadically in a unit of time.

In some embodiments, the second upload time period may be related to operating conditions and historical fault conditions of different gas terminal enterprises, as well as the second priority. A period during which gas terminal enterprises use large amounts of gas or have frequent historical faults may be selected as the second upload period. The second priority is positively correlated with the timing of the second upload period; the higher the second priority, the earlier the second upload period, and gas data is collected earlier. For example, gas terminal enterprises with a higher second priority may have their second upload periods closer to midnight.

In some embodiments, a length of the second upload time period and the second upload frequency are positively correlated with an amount of gas data generated by the gas terminal enterprise and the first priority, respectively. The higher the first priority of a gas terminal enterprise and the greater the amount of gas data generated by the gas terminal enterprise, the longer the length of the second upload time period and the higher the second upload frequency.

In some embodiments, the smart gas government safety supervision management platform may determine the second upload characteristic based on the operating conditions, historical fault conditions, first priority, second priority, and the amount of gas data generated by the gas terminal enterprises by querying a fifth preset table. The fifth preset table includes a correspondence between the operating conditions, historical fault conditions, first priority, second priority, the amount of gas data generated by the gas terminal enterprises, and their second upload characteristics. The fifth preset table may be determined based on prior experience or historical data.

In 280, generating an upload parameter instruction based on the second upload characteristic and sending the upload parameter instruction to the one or more groups of gas sensing devices of the gas terminal enterprises for storage, the upload parameter instruction instructing the one or more groups of gas sensing devices to collect and upload auxiliary data.

The upload parameter instruction may control the gas sensing devices to collect and upload auxiliary data. In some embodiments, the smart gas government safety supervision management platform may sequentially send the upload parameter instruction to the gas terminal enterprises through the smart gas government safety supervision sensor network platform, the smart gas government safety supervision object platform, and the smart gas company sensor network platform, and store the upload parameter instruction in the gas sensing devices.

The auxiliary data is gas data that is uploaded sporadically. The auxiliary data may be used to periodically report the gas usage of the gas terminal enterprises to the government. However, due to its limited amount, the auxiliary data does not allow for a more in-depth and detailed analysis of future hazards, potential failures, or the like.

Some embodiments of the present disclosure can realize data interaction between different gas terminal enterprises and the government platforms through the smart gas government safety supervision management platform of the IoT system for supervising enterprise information based on smart gas. By obtaining the needs of different gas terminal enterprises and providing data as needed, the IoT system for supervising enterprise information based on smart gas improves the efficiency of gas data interaction across enterprises and departments, reduces the workload of gas data interaction, and enhances the efficiency of government supervision while minimizing gas risks as much as possible.

FIG. 3 is a schematic diagram illustrating a correlation model of an IoT system according to some embodiments of the present disclosure. A correlation map 310 includes nodes 311 and edges 312, the nodes 311 correspond to gas terminal enterprises, and characteristics of the node 311 include types of the gas terminal enterprises and collections of gas data lists. The edges 312 connect any two of the gas terminal enterprises, and characteristics of the edges 312 include a correlation between the gas terminal enterprises connected by the edges. The correlation between the gas terminal enterprises at a future time point may be predicted based on a correlation model 320 and the correlation map 310, the correlation model 320 being a machine learning model.

The correlation map 310 refers to a graph reflecting the correlation between the terminal enterprises. In some embodiments, the correlation map 310 may be built based on types of a plurality of gas terminal enterprises and gas data lists. For example, the plurality of gas terminal enterprises may be treated as a plurality of nodes 311 of the correlation map, and an edge 312 is constructed between any two enterprises.

In some embodiments, the nodes 311 of the correlation map are gas terminal enterprises, and the characteristics of the edges may include the types of the gas terminal enterprises and a collection of gas data lists. The collection of gas data lists includes a current gas data list and a historical gas data list. The current gas data list and the historical gas data list are the gas data lists corresponding to data upload instructions currently and historically received by the gas terminal enterprises, respectively. More descriptions of the types of gas terminal enterprise and the gas data list may be found in the related description of FIG. 2.

In some embodiments, the edges 312 of the correlation map may characterize a correlation relationship between different nodes, and the characteristics of the edges may include a correlation. In some embodiments, edges with a correlation below a predetermined threshold may be hidden. More descriptions of determining the correlation may be found in the related description of FIG. 2.

In some embodiments, the correlation 330 between gas terminal enterprises at a future time point may be predicted by the correlation model 320 based on the correlation map 310.

The correlation model 320 may be a machine learning model. In some embodiments, the correlation model includes a graph neural network (GNN), with an input of the correlation model being the correlation map 310, and an output of the correlation model being a predicted correlation 330 at a future time point, for example, the predicted correlation 330 of two nodes at a future time point based on an output of the edge connecting the two nodes.

In some embodiments, the correlation model 320 may be trained through supervised learning. For example, a plurality of training samples with labels may be input into an initial correlation model, a loss function may be constructed from the labels and a result of the initial correlation model, and based on the loss function, parameters of the initial correlation model may be iteratively updated via gradient descent or other techniques. The model training is completed when a preset condition is met, and the trained correlation model is obtained. The preset condition may include the loss function converging, a count of iterations reaching a threshold, or the like.

The training samples may include sample correlation maps, and the labels corresponding to the training samples may be actual correlations between gas terminal enterprises in the sample correlation maps. The sample correlation maps may be constructed based on historical actual data or simulated data generated by the IoT system. The labels may be annotated based on the development of the historical actual data. For example, the labels may be annotated based on the gas data list presented by the smart gas government safety supervision management platform in the past. For subsequent gas data lists that are the same or similar, and for gas terminal enterprises of the same or similar types, their correlation may be annotated as 1. For other gas terminal enterprises that do not meet these similar conditions, the correlation may be annotated as a value between 0 and 1.

For different gas terminal enterprises, the correlation between them may change significantly over time because of the different magnitude of changes and fluctuations in gas consumption over time. The present disclosure establishes the correlation map based on the data of the gas terminal enterprises, and then processes the correlation map using the trained correlation model to predict the correlation at a future time point, which makes the prediction results more accurate and reasonable, reflecting actual conditions.

FIG. 4 is a flowchart illustrating an exemplary process for determining a correlation according to some embodiments of the present disclosure. As shown in FIG. 4, a process 400 includes the following operations. In some embodiments, the process 400 may be performed by a smart gas government safety supervision management platform of an IoT system for supervising enterprise information based on smart gas.

In 410, obtaining a plurality of list generation times corresponding to a plurality of gas data lists.

More descriptions of the gas data list may be found in the related descriptions of FIG. 2.

A list generation time refers to a time when the smart gas government safety supervision management platform proposes a corresponding gas data list, and the plurality of list generation times may form a time series.

In 420, determining a difference value for the plurality of gas data lists based on the plurality of list generation times.

The difference value is the magnitude of a difference between different gas data lists. In some embodiments, the smart gas government safety supervision management platform may determine the difference value based on a vector distance through clustering analysis. The smart gas government safety supervision management platform may generate a current gas data list based on historical gas data lists, determine at least one clustering center based on clustering of types and contents of the historical gas data lists, determine the vector distance between the current gas data list and the historical gas data lists corresponding to the at least one clustering center, and then determine the difference value through a preset correspondence.

The preset correspondence refers to a predetermined relationship between the vector distance from the current gas data list to the at least one clustering center and the corresponding difference value of the gas data list. For example, the difference value may be numerically identical to the vector distance.

For example, the current gas data list is the gas data list for the 30th of a month, and the historical gas data lists are 29 gas data lists for the 1st to the 29th of the month, cluster analysis may be performed on the 29 historical gas data lists to determine at least one clustering center. Then the vector distance between the current gas data list and the at least one clustering center may be determined, respectively, and a minimum value of the vector distance may be determined as the difference value.

In some embodiments, the difference value of the gas data list may be obtained by weighting sub-difference values.

A sub-difference value is the magnitude of a difference between the current gas data list and a historical gas data list. In some embodiments, the smart gas government safety supervision management platform may determine a vector distance between the clustering center corresponding to each historical gas data list and the current gas data list respectively, thereby determining the sub-difference values through a preset correspondence. In some embodiments, the smart gas government safety supervision management platform may normalize the sub-difference values in a variety of ways. For example, the smart gas government safety supervision management platform may normalize the current gas data list as a ratio of an initial sub-difference value to a sum of all sub-difference values as the sub-difference value.

In some embodiments, the smart gas government safety supervision management platform may determine the difference value in a variety of ways. For example, the smart gas government safety supervision management platform may determine the difference value by weighting the sub-difference values.

In some embodiments, a weight of a sub-difference value is related to an occurrence time of a historical gas data list corresponding to the sub-difference value. A time interval between the occurrence time of the historical gas data list and an occurrence time of the current gas data list is negatively correlated with the weight of the sub-difference value.

The difference value is positively correlated with a ratio of the sub-difference value to the time interval. The time interval is the time interval between the occurrence time of the historical gas data list corresponding to the sub-difference value and the occurrence time of the current gas data list. In some embodiments, the time interval is required to satisfy an interval condition, which may be the time interval being greater than a minimum interval threshold. The minimum interval threshold is a predetermined minimum value of an acceptable time interval, and the minimum time interval may ensure that the time interval, when involved in the determination of the difference value, does not result in a difference value that is too large and affects the determination. The time interval may be determined in days.

In some embodiments, the smart gas government safety supervision management platform may determine the difference value using Equation (2):

$$β = {Σ}_{i = 0}^{n} \frac{β {0}_{i}}{{t}_{i}} \qquad ( 2 )$$

Wherein, B denotes the difference value, β0ᵢ; denotes the sub-difference value corresponding to a historical gas data list i, tᵢ denotes the time interval between the historical gas data list i and the current gas data list, and n denotes the count of historical gas data lists.

Exemplarily, if the current gas data list is the gas data list for the 30th of a month, and the historical gas data lists are 29 gas data lists for the 1st to the 29th of the month. Therefore, there are 29 sub-difference values between the current gas data list and the 29 historical gas data lists, each sub-difference value corresponding to one of the 29 historical gas data lists. The time interval between the historical gas data list for the 3rd of the month and the current gas data list for the 30th of the month is 27 days. Based on the vector distance between the clustering center corresponding to the current gas data list for the 30th of the month and the historical gas data list for the 3rd of the month, the sub-difference value corresponding to the historical gas data list for the 3rd of the month may be determined.

Some embodiments of the present disclosure determine the difference value of the current gas data list based on the sub-difference values, which allows for accurate consideration of the difference between each historical gas data list and the current gas data list, thereby ensure accuracy of the correlation.

In 430, updating a correlation map in response to the difference value satisfying a predetermined difference condition.

The predetermined difference condition is a condition that needs to be met by the difference value when updating the correlation map. The predetermined difference condition may be preset manually. The predetermined difference condition may include the difference value being greater than a difference value threshold, wherein the difference value threshold is a minimum manually preset difference value.

In some embodiments, in response to the difference value satisfying the predetermined difference condition, the smart gas government safety supervision management platform may re-determine the correlation between the gas terminal enterprises based on the type of the current gas terminal enterprise and the gas data list. More descriptions of determining the correlation may be found in FIG. 2 and FIG. 3 and the related descriptions. The smart gas government safety supervision management platform may update the correlation map by assigning the re-determined correlation to the characteristics of the edges in the corresponding correlation map.

In 440, determining an updated correlation between gas terminal enterprises at a future time point based on an updated correlation map.

The updated correlation refers to a correlation determined using the updated correlation map. In some embodiments, the smart gas government safety supervision management platform may determine the updated correlation through table lookup, model training, or the like. More descriptions of determining the updated correlation may refer to the descriptions of determining the correlation in FIG. 2 and FIG. 3.

In 450, performing a labeling process on the gas terminal enterprises based on the updated correlation, and updating one or more gas terminal enterprise groups.

In some embodiments, the smart gas government safety supervision management platform may update one or more gas terminal enterprise groups by performing a tagging process based on the updated correlation between the gas terminal enterprises. More descriptions of the labeling process based on the correlation may be found in the related descriptions of FIG. 2.

Due to different time points of the smart gas data proposed by the smart gas government safety supervision management platform, some embodiments of the present disclosure ensure data timeliness by updating the correlation based on demand differences between the current gas data list and the historical gas data list, thereby improving rationality of the correlation.

FIG. 5 is a flowchart illustrating an exemplary process for obtaining sampling data according to some embodiments of the present disclosure. As shown in FIG. 5, a process 500 includes the following operations. In some embodiments, the process 500 may be performed by a smart gas government safety supervision management platform of an IoT system for supervising enterprise information based on smart gas.

Operation 510 includes two sub-operations, 510-1 and 510-2. In some embodiments, the sub-operations 510-1 and 510-2 may be performed simultaneously.

In 510-1, obtaining sampling data from one or more gas user platforms based on a gas user service platform; in 510-2, obtaining sampling data from one or more gas user object platforms and smart gas device object platforms based on a smart gas company sensor network platform.

More descriptions of the gas user service platform, the smart gas company sensor network platform, the gas user object platform, and the smart gas device object platform may be found in FIG. 1 and the related descriptions. More descriptions of the sampling data may be found in FIG. 2 and the related descriptions.

In some embodiments, the sampling data is related to a gas data list. In some embodiments, the smart gas government safety supervision management platform may determine an acquisition time of the sampling data by querying a sixth preset table based on a list generation time of the gas data list and a type of the gas data list. The acquisition time of the sampling data refers to the time when the sampling data is acquired. The sixth preset table includes a correspondence between acquisition times of sampling data and list generation times of gas data lists and types of the gas data lists. The sixth preset table may be determined based on prior experience or historical data. More descriptions of the gas data list and the list generation time may be found in FIGS. 2-3 and the related descriptions.

In some embodiments, the smart gas government safety supervision management platform may determine a gas terminal enterprise that satisfies a predetermined enterprise condition as a target enterprise, and obtain the sampling data of the target enterprise.

The target enterprise is a gas terminal enterprise used for obtaining sampling data. In some embodiments, the smart gas government safety supervision management platform may determine a gas terminal enterprise that satisfies a predetermined enterprise condition as the target enterprise.

The predetermined enterprise condition is a condition for selecting the target enterprise. The predetermined enterprise condition may include the correlation with at least one gas terminal enterprise being greater than a correlation threshold, a similarity between a gas data list corresponding to a data upload instruction and a historical gas data list being greater than a similarity threshold, etc. The similarity threshold may be preset manually.

More descriptions of the correlation and the correlation threshold may be found in FIG. 2 and the related descriptions thereof.

The similarity refers to the degree of similarity between different gas data lists. The more similar the types of gas data lists and the closer the occurrence times of the gas data lists are, the higher the similarity is. In some embodiments, the smart gas government safety supervision management platform may determine the similarity in various ways based on a vector distance between a current gas data list and at least one clustering center corresponding to historical gas data lists.

The vector distance between the current gas data list and the at least one clustering center corresponding to the historical gas data list and is negatively correlated with the similarity. For example, the smart gas government safety supervision management platform may determine the similarity using Equation (3):

$$γ = \frac{{e}^{- t}}{d} \qquad ( 3 )$$

wherein y denotes the similarity, d denotes the vector distance between the current gas data list and at least one clustering center corresponding to the historical gas data list and, and t denotes a time interval between the occurrence time of the historical gas data list and the occurrence time of the current gas data list.

For example, if the current gas data list is for the 30th of a month, and the historical gas data lists are 29 lists for the 1st to the 29th of the month respectively, clustering analysis may be performed on the 29 historical gas data lists to determine at least one clustering center. Then, vector distance between the current gas data list and the at least one clustering center may be determined, and the similarity may be determined by taking a minimum value of the vector distance.

In some embodiments, the smart gas government safety supervision management platform may obtain the sampling data of the target enterprise via a gas detection device of the target enterprise.

Some embodiments of the present disclosure reduce target sources for obtaining the sampling data and improve the efficiency of data processing by considering both the correlation and the similarity when selecting the target enterprise.

In some embodiments, the smart gas government safety supervision management platform may determine an urgency degree of the gas data list based on the list generation time of the gas data list and the type of the gas data list; determine a collection sequence of the sampling data corresponding to the gas data list based on the urgency degree of the gas data list; and obtain the sampling data based on the collection sequence.

The urgency degree refers to the urgency of completing the gas data list. In some embodiments, the smart gas government safety supervision management platform may determine the urgency degree of the gas data list in various ways. For example, the smart gas government safety supervision management platform may determine the urgency degree based on a preset importance level and a time coefficient.

The preset importance level is a predefined importance value determined based on the type of the gas data list. The preset importance level may be manually preset. The preset importance level is positively correlated with the urgency degree. The time coefficient is a coefficient determined based on a time interval between the occurrence time of the historical gas data lists in a current batch and a current time.

In some embodiments, the time coefficient may be obtained by normalizing the time interval between the occurrence time of the historical gas data lists in the current batch and the current time. For example, the time coefficient for a historical gas data list with respect to the current gas data list may be a ratio of the time interval corresponding to the historical gas data list to the total time interval corresponding to all historical gas data lists in the current batch. The time coefficient of the historical gas data list with respect to the current gas data list is positively correlated with the urgency degree.

In some embodiments, the smart gas government safety supervision management platform may designate a product of the preset importance level and the time coefficient as the urgency degree.

Exemplarily, if the current batch includes a total of 30 gas data lists for the 1st to the 30th of a month, and the current date is the 30th of the month, then the time interval corresponding to the gas data list for the 6th of the month is 24 days, the total time interval for all gas data lists in the current batch is (0+1+2+ . . . +29), so the time coefficient corresponding to the gas data list for the 6th of the month is

$$\frac{24}{( 0 + 1 + 2 + … … + 29 )} .$$

In some embodiments, the smart gas government safety supervision management platform may sort gas data lists based on the urgency degree. The higher the urgency degree of a gas data list is, the higher the gas data list is ranked, the earlier the sampling data is obtained.

Due to limitations in platform data transmission rates and bandwidth, the acquisition time for sampling data needs to be planned to ensure data processing efficiency. Some embodiments of the present disclosure ensure priority acquisition of sampling data for urgent data needs by determining the urgency degree of different gas data lists, sorting the gas data lists based on the urgency degree, and acquiring the sampling data in sequence, thereby satisfying the data needs of the smart gas government safety supervision management platform.

In 520, determining a gas data feedback based on the sampling data and sending the gas data feedback to the gas terminal enterprise that uploads the sampling data.

The gas data feedback refers to feedback information on the sampling data. The gas data feedback may include feedback on the successful receipt of the sampling data, requests for additional gas data uploads, etc.

Some embodiments of the present disclosure ensure the quality of the sampling data and improve data processing efficiency through various means, such as selecting the target enterprise and determining the source and time for acquiring the sampling data based on the correlation and the similarity.

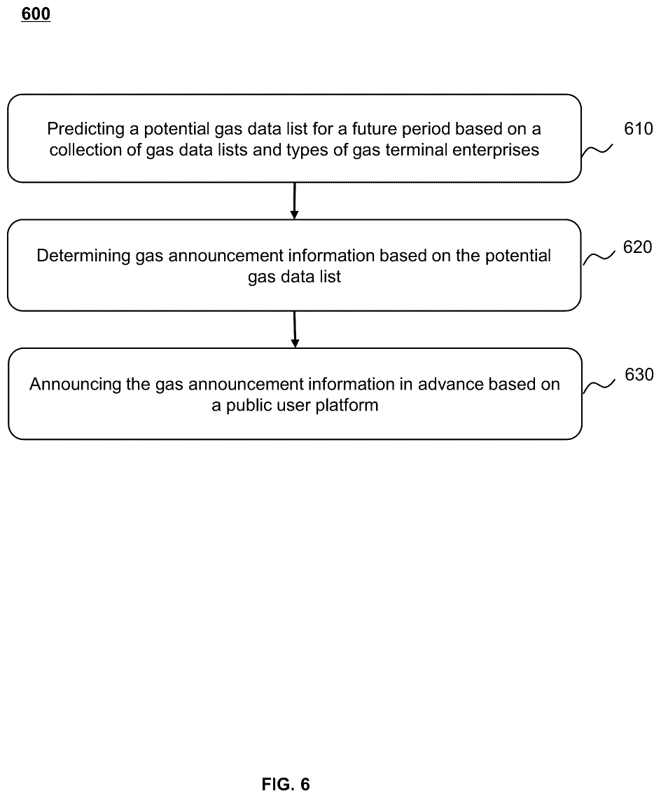

FIG. 6 is a flowchart illustrating an exemplary process for obtaining sampling data according to some embodiments of the present disclosure. As illustrated in FIG. 6, a process 600 includes the following operations. In some embodiments, the process 600 may be performed by a smart gas government safety supervision management platform of an IoT system for supervising gas enterprise information based on smart gas.

In 610, predicting a potential gas data list for a future period based on a collection of gas data lists and types of gas terminal enterprises.

More descriptions of the types of gas terminal enterprises may be found in FIG. 2 and the related descriptions thereof.

The collection of gas data lists refers to the collection of current gas data lists and historical gas data lists.

The potential gas data list is a gas data list that may appear in a future period. In some embodiments, the smart gas governance safety supervision management platform may predict the potential gas data list based on an actual historical gas data list that occurred in a same period. For example, the smart gas government safety supervision management platform may designate an actual historical gas data list that occurred in the September of a previous year as the potential gas data list for the September of a current year.

In some embodiments, the smart gas government safety supervision management platform may determine the potential gas data list for the future period through a data demand model based on the collection of gas data lists, the types of the gas terminal enterprises, and the future period.

The data demand model is a model used to determine the potential gas data list. The data demand model may be a machine learning model, such as a deep neural networks (DNN) model.

In some embodiments, an input of the data demand model may include a historical gas data list, a current gas data list, the type of gas terminal enterprises, and a future period; and an output of the data demand model may include the potential gas data list for the future period.

The future period is a time period in the future with a preset time interval from the current time. The preset time interval may be predetermined manually.

In some embodiments, the smart gas governance safety supervision management platform may train the data demand model based on data samples with data labels through supervised learning. For example, the smart gas government safety supervision management platform may input a plurality of data samples with data labels into an initial data demand model, construct a loss function based on a result of the initial data demand model and the data labels, and iteratively update parameters of the initial data demand model based on the loss function using gradient descent or other techniques. The model training is completed when a preset condition is met, and the trained data demand model is obtained. The preset condition may include the loss function converging, a count of iterations reaching a threshold, or the like.

The data samples may include sample historical gas data lists of sample gas terminal enterprises in a first historical time period, sample gas data lists of sample gas terminal enterprises at a second historical time point, types of the sample gas terminal enterprises at the second historical time point, and a third historical time period. The data labels may be actual gas data lists of the sample gas terminal enterprises in the third historical time period. The first historical time period precedes the second historical time point, and the second historical time point precedes the third historical time period. The data samples and data labels may be obtained based on historical data.

In some embodiments, the data demand model may be obtained through iterative training of the initial data demand model based on different sets of training samples.

A set of training samples may include a plurality of training samples with labels, and the training samples in the different sets of training samples have different learning rates during a training process. The training samples may be determined based on historical data of each gas terminal enterprise in each group of one or more gas terminal enterprise groups. The historical data includes a collection of historical gas data lists, historical types, and historical sample times for the gas terminal enterprises. The labels include actual gas data lists for the gas terminal enterprises at the historical sample times. The labels may be determined and annotated based on the actual gas data lists in the historical data.

The learning rate is a parameter characterizing a step size of the iterative updating of the model parameters during model training. The learning rate may be a sequence of learning rate data, including learning rates for a plurality of training stages. The higher the learning rate is, the larger the step size for updating the model parameters.

The learning rate may be adjusted based on sample characteristics of the training samples. The sample characteristics of the training samples are inherent properties of the training samples. For example, the sample characteristics of the training samples may include a source of the training samples, a reliability of the training samples, or the like. For example, the source of the training samples may include the types of the gas terminal enterprises from which the training samples are sourced. The reliability of the training samples refers to a degree of consistency of the labels of the training samples. For example, if the actual gas data lists corresponding to the gas terminal enterprises in a gas terminal enterprise group have many types, and the labels may not be easily annotated, then the training effect is poor, and the reliability of the training samples is low. If the types of the actual gas data list corresponding to the gas terminal enterprises in a gas terminal enterprise group are more consistent, with only fixed data variations, the labels are easier to annotate, the training effect is better, and the reliability of the training samples is higher.

In some embodiments, the smart gas government safety supervision management platform may determine the learning rate of the training samples of different sets of training samples by querying a vector database based on the characteristics of the training samples. Elements of vectors in the vector database at least include the types of the gas terminal enterprises and the reliability of the training samples. The smart gas government safety supervision management platform may construct feature vectors based on the types of the gas terminal enterprises and the reliability of the training samples and construct at least one reference vector based on the types of historical gas terminal enterprises and the reliability of historical training samples. By determining vector distance between the feature vectors and the at least one reference vector, the learning rate corresponding to the reference vector with a smallest vector distance may be designated as a current learning rate. The learning rate corresponding to the reference vector may be determined based on historical experience, historical data statistics, preset values, or the like.

In some embodiments, the smart gas government safety supervision management platform may alternately training the initial data demand model based on sizes of the different sets of training samples. The size of a set of training samples may be determined based on an amount of data in the set of training samples. The larger the amount of data is, the larger the size of the set of training samples is. The data demand model may be trained based on different sizes of the different sets of training samples separately. More descriptions of the separate training may be found in the descriptions of the supervised learning above. Each set of training samples may have its own independent loss function during the separate training.

In some embodiments of the present disclosure, by dividing the training samples into different sets and alternate the training based on the sizes of different sets of training samples, reduce the amount of data for each training session can be reduced and the training efficiency can be improved.

In some embodiments of the present disclosure, the gas data list of proposed by the smart gas government safety supervision management platform in a future period can be more accurately and reasonably predict through the trained data demand model, may relatively accurately and reasonably predict a gas data list for the in a future time period. Consequently, for the gas data list in the future period, data extraction, data collection, and information announcements can be prepared in advance, thereby fully meeting the data demand of the smart gas government safety supervision management platform and improving the efficiency of gas enterprise information processing.

In 620, determining gas announcement information based on the potential gas data list.

The gas announcement information refers to gas-related information announced based on a public user platform. In some embodiments, the gas announcement information may be related to the potential gas data list. For example, the gas announcement information may include the potential gas data list in a future period in order to prompt relevant gas terminal enterprises to prepare for uploading gas data.

In 630, announcing the gas announcement information in advance based on a public user platform.

In some embodiments of the present disclosure, by predicting the potential gas data list, gas terminal enterprises that need to upload gas data may be notified in advance so that the gas terminal enterprises can prepare for data uploads, thereby improve the efficiency of gas data interaction between the government and the gas terminal enterprises.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

As another example, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for supervising enterprise information based on smart gas, implemented by a smart gas government safety supervision management platform of an Internet of Things (IoT) system for supervising enterprise information based on smart gas, the method comprising:
determining a gas data list, wherein the gas data list includes at least one of a periodic check list or a statistical list;
determining a correlation between gas terminal enterprises based on the gas data list and types of the gas terminal enterprises;
determining one or more gas terminal enterprise groups by performing a labeling process on the gas terminal enterprises based on the correlation;
determining, for each group of the one or more gas terminal enterprise groups, a first upload characteristic of gas terminal enterprises in the group based on grouping of the one or more gas terminal enterprise groups, the first upload characteristic including at least one of a first upload time period or a first upload frequency;
determining a data upload instruction based on the first upload characteristic and the gas data list, and sending the data upload instruction to a corresponding gas terminal enterprise among the gas terminal enterprises;
obtaining sampling data uploaded by the gas terminal enterprises, the sampling data being collected by one or more groups of gas sensing devices controlled by the gas terminal enterprises based on the data upload instruction;
determining a second upload characteristic of the gas terminal enterprises in each group of the one or more gas terminal enterprise groups based on a first priority of each group of the one or more gas terminal enterprise groups and a second priority of each of the gas terminal enterprises in the group, the second upload characteristic including a second upload frequency; and
generating an upload parameter instruction based on the second upload characteristic and sending the upload parameter instruction to the one or more groups of gas sensing devices of the gas terminal enterprises for storage, the upload parameter instruction instructing the one or more groups of gas sensing devices to collect and upload auxiliary data.

2. The method of claim 1, wherein the determining a correlation between gas terminal enterprises based on the gas data list and types of the gas terminal enterprises includes:
establishing a correlation map based on the gas data list and the types of the gas terminal enterprises; and
predicting the correlation between the gas terminal enterprises at a future time point based on the correlation map, wherein the types of the gas terminal enterprises include a first correlation enterprise and a second correlation enterprise, and the types of the gas terminal enterprises are determined based on a gas usage of the gas terminal enterprises during a predetermined historical time period.

3. The method of claim 2, wherein the correlation map includes nodes and edges, the nodes correspond to the gas terminal enterprises, characteristics of the nodes include the types of the gas terminal enterprises, a collection of gas data lists; the edges connect any two of the gas terminal enterprises, characteristics of the edges include the correlation between the gas terminal enterprises connected by the edges; and
the predicting the correlation between the gas terminal enterprises at a future time point based on the correlation map includes:
predicting the correlation between the gas terminal enterprises at the future time point by a correlation model based on the correlation map, the correlation model being a machine learning model.

4. The method of claim 2, wherein the predicting the correlation between the gas terminal enterprises at a future time point based on the correlation map includes:
obtaining a plurality of list generation times corresponding to a plurality of gas data lists;
determining a difference value for the plurality of gas data lists based on the plurality of list generation times;
updating the correlation map in response to the difference value satisfying a predetermined difference condition;
determining an updated correlation between the gas terminal enterprises at the future time point based on an updated correlation map; and
performing a labeling process on the gas terminal enterprises based on the updated correlation, and updating the one or more gas terminal enterprise groups.

5. The method of claim 1, wherein the obtaining sampling data uploaded by the gas terminal enterprises includes:
obtaining the sampling data from one or more gas user platforms based on a gas user service platform;
obtaining the sampling data from one or more gas user object platforms and smart gas device object platforms based on a smart gas company sensing network platform, wherein the sampling data is related to the gas data list, and an acquisition time of the sampling data is determined based on a list generation time of the gas data list and a type of the gas data list; and
determining a gas data feedback based on the sampling data and sending the gas data feedback to the gas terminal enterprises that upload the sampling data.

6. The method of claim 5, wherein the obtaining sampling data uploaded by the gas terminal enterprises further includes:
determining a gas terminal enterprise that satisfies a predetermined enterprise condition as a target enterprise, the predetermined enterprise condition including the correlation with at least one gas terminal enterprise being greater than a correlation threshold, a similarity between a gas data list corresponding to the data upload instruction and a historical gas data list being greater than a similarity threshold; and
obtaining the sampling data of the target enterprise.

7. The method of claim 5, wherein the obtaining sampling data uploaded by the gas terminal enterprises further includes:
determining an urgency degree of the gas data list based on the list generation time of the gas data list and the type of the gas data list;
determining a collection sequence of the sampling data corresponding to the gas data list based on the urgency degree of the gas data list; and
obtaining the sampling data based on the collection sequence.

8. The method of claim 1, further comprising:
predicting a potential gas data list for a future period based on a collection of gas data lists and the types of the gas terminal enterprises;
determining gas announcement information based on the potential gas data list; and
announcing the gas announcement information in advance based on a public user platform.

9. The method of claim 8, wherein the predicting a potential gas data list for a future period based on a collection of gas data lists and the types of the gas terminal enterprises includes:
determining the potential gas data list for the future period by a data demand model based on the collection of gas data lists, the types of the gas terminal enterprises, and the future period, the data demand model being a machine learning model.

10. The method of claim 9, wherein the data demand model is obtained by alternately training an initial data demand model based on different sets of training samples, the different sets of training samples include a plurality of training samples with labels, the plurality of training samples of the different sets of training samples have different learning rates during a training process, the learning rates being adjusted based on sample characteristics of the plurality of training samples; and
the plurality of training samples are determined based on historical data of the gas terminal enterprises in each group of the one or more gas terminal enterprise groups, the historical data includes a collection of historical gas data lists, historical types, and historical sample times of the gas terminal enterprises, and the labels include actual gas data lists of the gas terminal enterprises at the historical sample times.

11. An Internet of Things (IoT) system for supervising enterprise information based on smart gas, the system comprising a public user platform, a smart gas government safety supervision service platform, a smart gas government safety supervision management platform, a smart gas government safety supervision sensor network platform, a gas user platform, a gas user service platform, a smart gas government safety supervision object platform, a smart gas company sensor network platform, a gas user object platform, and a smart gas device object platform; wherein
the smart gas government safety supervision management platform is configured to:
determine a gas data list, wherein the gas data list includes at least one of a periodic check list or a statistical list, and the gas data list is uploaded to the smart gas government safety supervision sensor network platform through the smart gas government safety supervision management platform;
determine, based on the smart gas government safety supervision object platform, a correlation between gas terminal enterprises based on the gas data list and types of the gas terminal enterprises;
determine, based on the smart gas government safety supervision object platform, one or more gas terminal enterprise groups by performing a labeling process on the gas terminal enterprises based on the correlation;
determine, for each group of the one or more gas terminal enterprise groups, a first upload characteristic of gas terminal enterprises in the group based on grouping of the one or more gas terminal enterprise groups, the first upload characteristic including at least one of a first upload time period or a first upload frequency;
determine a data upload instruction based on the first upload characteristic and the gas data list, and send the data upload instruction to a corresponding gas terminal enterprise among the gas terminal enterprises;
obtain sampling data uploaded by the gas terminal enterprises, the sampling data being collected by one or more groups of gas sensing devices controlled by the gas terminal enterprises based on the data upload instruction;
determine a second upload characteristic of the gas terminal enterprises in each group of the one or more gas terminal enterprise groups based on a first priority of each group of the one or more gas terminal enterprise groups and a second priority of each of the gas terminal enterprises in the group, the second upload characteristic including a second upload frequency; and
generate an upload parameter instruction based on the second upload characteristic and send the upload parameter instruction to the one or more groups of gas sensing devices of the gas terminal enterprises for storage, the upload parameter instruction instructing the one or more groups of gas sensing devices to collect and upload auxiliary data.

12. The IoT system of claim 11, wherein the smart gas government safety supervision management platform is further configured to:
establish a correlation map based on the gas data list and the types of the gas terminal enterprises; and
predict the correlation between the gas terminal enterprises at a future time point based on the correlation map, wherein the types of the gas terminal enterprises include a first correlation enterprise and a second correlation enterprise, and the types of the gas terminal enterprises are determined based on a gas usage of the gas terminal enterprises during a predetermined historical time period.

13. The IoT system of claim 12, wherein the correlation map includes nodes and edges, the nodes correspond to the gas terminal enterprises, characteristics of the nodes include the types of the gas terminal enterprises, a collection of gas data lists; the edges connect any two of the gas terminal enterprises, characteristics of the edges include the correlation between the gas terminal enterprises connected by the edges; and
the predicting the correlation between the gas terminal enterprises at a future time point based on the correlation map includes:
predicting the correlation between the gas terminal enterprises at the future time point by a correlation model based on the correlation map, the correlation model being a machine learning model.

14. The IoT system of claim 12, wherein the smart gas government safety supervision management platform is further configured to:
obtain a plurality of list generation times corresponding to a plurality of gas data lists;
determine a difference value for the plurality of gas data lists based on the plurality of list generation times;
update the correlation map in response to the difference value satisfying a predetermined difference condition;
determine an updated correlation between the gas terminal enterprises at the future time point based on an updated correlation map; and
perform a labeling process on the gas terminal enterprises based on the updated correlation, and update the one or more gas terminal enterprise groups.

15. The IoT system of claim 11, wherein the smart gas government safety supervision management platform is further configured to:
obtain the sampling data from one or more gas user platforms based on the gas user service platform;
obtain the sampling data from one or more gas user object platforms and smart gas device object platforms based on the smart gas company sensing network platform, wherein the sampling data is related to the gas data list, and an acquisition time of the sampling data is determined based on a list generation time of the gas data list and a type of the gas data list; and
determine a gas data feedback based on the sampling data and send the gas data feedback to the gas terminal enterprises that upload the sampling data.

16. The IoT system of claim 15, wherein the smart gas government safety supervision management platform is further configured to:
determine a gas terminal enterprise that satisfies a predetermined enterprise condition as a target enterprise, the predetermined enterprise condition including the correlation with at least one gas terminal enterprise being greater than a correlation threshold, a similarity between a gas data list corresponding to the data upload instruction and a historical gas data list being greater than a similarity threshold; and
obtain the sampling data of the target enterprise.

17. The IoT system of claim 15, wherein the smart gas government safety supervision management platform is further configured to:
determine an urgency degree of the gas data list based on the list generation time of the gas data list and the type of the gas data list;
determine a collection sequence of the sampling data corresponding to the gas data list based on the urgency degree of the gas data list; and
obtain the sampling data based on the collection sequence.

18. The IoT system of claim 11, wherein the smart gas government safety supervision management platform is further configured to:
predict a potential gas data list for a future period based on a collection of gas data lists and the types of the gas terminal enterprises;
determine gas announcement information based on the potential gas data list; and
announce the gas announcement information in advance based on the public user platform.

19. The IoT system of claim 18, wherein the smart gas government safety supervision management platform is further configured to:
determine the potential gas data list for the future period by a data demand model based on the collection of gas data lists, the types of the gas terminal enterprises, and the future period, the data demand model being a machine learning model.

20. The IoT system of claim 19, wherein the data demand model is obtained by alternately training an initial data demand model based on different sets of training samples, the different sets of training samples include a plurality of training samples with labels, the plurality of training samples of the different sets of training samples have different learning rates during a training process, the learning rates being adjusted based on sample characteristics of the plurality of training samples; and
the plurality of training samples are determined based on historical data of the gas terminal enterprises in each group of the one or more gas terminal enterprise groups, the historical data includes a collection of historical gas data lists, historical types, and historical sample times of the gas terminal enterprises, and the labels include actual gas data lists of the gas terminal enterprises at the historical sample times.
